(19) United States
(12) Patent Application Publication
(10) Pub. No.: US 2011/0294972 A1
(43) Pub. Date: Dec. 1, 2011

(54) Olefin Polymerization Catalysts

(75) Inventors: Reynald Chevalier, Frankfurt (DE); Sandor Nagy, Naperville, IL (US)

(73) Assignee: BASELL POLYOLEFINE GMBH, Wesseling (DE)

(21) Appl. No.: 13/110,186

(22) Filed: May 18, 2011

Related U.S. Application Data
(60) Provisional application No. 61/396,477, filed on May 27, 2010.

(51) Int. Cl. C08F 4/76; B01J 31/22; C07F 7/00

(52) U.S. Cl. 526/190; 548/103; 502/155

(57) ABSTRACT

The invention relates to transition metal complexes comprising a metal of group 3, 4, or 6 of the Periodic Table of the Elements and one, or two mono-anionic triazole ligands It has been found that these transition metal complexes which comprise at least one triazole fragment having a substituent with an unsaturated fragment are suitable as precatalysts for the polymerization of olefins. In these complexes one carbon atom of the unsaturated fragment is bound directly or via a bridge to a triazole group and the other carbon atom is bound to the transition metal. The complexes are useful as catalysts for olefin polymerization, a catalyst system comprising these complexes and a process for the polymerization of olefins under the use of the catalyst system.

### CROSS-REFERENCE TO RELATED APPLICATIONS

This application claims the benefit under 35 U.S.C. 119(e) of U.S. Provisional Application No. 61/396,477, filed May 27, 2010. The disclosure of U.S. Provisional Application No. 61/396,477 as filed is incorporated herein by reference.

The invention relates to complexes useful as precatalysts for olefin polymerization, a catalyst system comprising these complexes and a process for the polymerization of olefins under the use of the catalyst system.

As well known various catalysts exist for homopolymerization and copolymerization of olefins. New polymerization complexes are of great interest in industry because they offer many new opportunities for new processes and products with superior properties.

In WO 03/101936 A1 new bis(triazole) group (IV) tetrachloride complexes are disclosed which are used as precatalysts for the polymerization and copolymerization of α-olefins. Titanium derivatives are described 100 times more active than zirconium and hafnium derivatives. Further triazole complexes have been described in literature for other applications, e.g. ruthenium complexes in Organometallics 2008, Vol. 27, No. 21, pp. 5430-5433 and iridium complexes in Organometallics 2009, Vol. 28, No. 18, 2009, pp. 5468-5488 both for optoelectronic applications.

It is an object of the present invention to provide further complexes useful as precatalysts for olefin polymerization.

It has been found that special transition metal complexes which comprise a bidentate triazole group are suitable as precatalysts for the polymerization of olefins. The complexes useful as precatalysts for olefin polymerization and copolymerization are transition metal complexes of group 3, 4, and 6 comprising one or two mono-anionic, bidentate triazole ligands, wherein a triazole group of each ligand has a substituent comprising an unsaturated fragment, wherein one carbon atom of the unsaturated fragment is bound directly or via a bridge to a triazole group and the other carbon atom is bound to the transition metal.

Preferred complexes have the structure of formula (I)

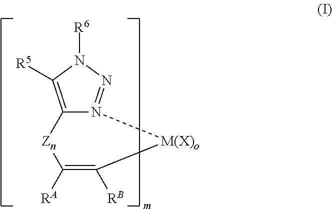

wherein
M is an element of group 3, 4 or 6 of the Periodic Table of the Elements,
Z is a bridge between the triazole group and the unsaturated fragment selected from —CR¹²R¹³—, —CR¹²R¹³—CR¹⁴R¹⁵—, —CR¹²R¹³—CR¹⁴R¹⁵—CR¹⁶R¹⁷—, —CR¹²═CR¹³—, —CR¹²R¹³—CO—, —CR¹²R¹³—CR¹⁴R¹⁵—CO—, —CR¹²R¹³—NR¹⁴—, —NR¹²—, —NR¹²—NR¹³—, —N(NR¹²R¹³)—, —PR¹²—, —P(O)R¹²—, —O—, —CO—, —CR¹²R¹³—O—, —CR¹²R¹³—S—, —S—, —SO—, —SO₂—, —L¹R¹²R¹³—, —L¹R¹²R¹³— L²R¹⁴R¹⁵—, —L¹R¹²R¹³—L²R¹⁴R¹⁵—L³R¹⁶R¹⁷—, —L¹R¹²R¹³—CR¹⁴R¹⁵—, —L¹R¹²R¹³—NR¹⁴—, —L¹R¹²R¹³—O— and —L¹R¹²R¹³—S—,
wherein
L¹-L³ are each, independently of one another, silicon or germanium,
R¹², R¹³, R¹⁴, R¹⁵, R¹⁶, and R¹⁷ are each, independently of one another, hydrogen or an organic radical having from 1 to 40 carbon atoms, or two vicinal radicals selected from R¹², R¹³, R¹⁴, R¹⁵, R¹⁶, and R¹⁷ form a monocyclic or polycyclic, substituted or unsubstituted ring system which has from 6 to 40 carbon atoms, wherein R¹², R¹³, R¹⁴, R¹⁵, R¹⁶, and R¹⁷ may also contain heteroatoms selected from the group consisting of the elements Si, N, O and S and may be substituted by one or more halogen atoms;
n is 0 or 1;
R^{A}, R^{B}, R⁵, and R⁶ are identical or different and are each hydrogen or an organic radical having from 1 to 40 carbon atoms, and the two vicinal radicals R^{A} and R^{B} may also form a monocyclic or polycyclic, substituted or unsubstituted ring system which has from 6 to 40 carbon atoms, wherein R^{A}, R^{B}, R⁵, and R⁶ may also contain heteroatoms selected from the group consisting of the elements Si, N, O and S and may be substituted by one or more halogen atoms;
m is 1 or 2;
the radicals X are identical or different and are each a halogen or an organic radical having from 1 to 40 carbon atoms, with two geminal radicals X also being able to be joined to one another;
o is 0, 1, 2 or 3 with provision m+o=2, 3, or 4 depending on the oxidation state of the transition metal.

Preferably the complex is defined by formula (Ia)

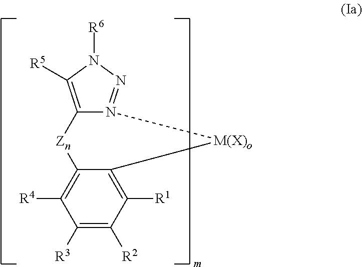

wherein M, X, o, Z, n, R⁵, and R⁶, and m are defined as for formula (I), and
R¹, R², R³, and R⁴ are identical or different and are each hydrogen or an organic radical having from 1 to 40 carbon atoms, or two vicinal radicals selected from R¹, R², R³, and R⁴ form a monocyclic or polycyclic, substituted or unsubstituted ring system which has from 6 to 40 carbon atoms, wherein R¹, R², R³, and R⁴ may also contain heteroatoms selected from the group consisting of the elements Si, N, O and S and may be substituted by one or more halogen atoms.

M is an element of group 3, 4 or 6 of the Periodic Table of the Elements. Preferred examples for M being an element of group 3 of the Periodic Table of the Elements are scandium and yttrium. Preferred examples for M being an element of group 4 of the Periodic Table of the Elements are titanium, zirconium and hafnium. Preferred examples for M being an element of group 6 of the Periodic Table of the Elements are chromium, molybdenum and tungsten. More preferably, M is titanium, zirconium, hafnium, or chromium. Especially preferred is M being zirconium or hafnium and especially zirconium.

Z is a bridge between the triazole group and the unsaturated fragment of the substituent selected from —CR¹²R¹³—, —CR¹²R¹³—CR¹⁴R¹⁵—, —CR¹²R¹³—CR¹⁴R¹⁵—CR¹⁶R¹⁷—, —CR¹²═CR¹³—, —CR¹²R¹³—CO—, —CR¹²R¹³—CR¹⁴R¹⁵—CO—, —CR¹²R¹³—NR¹⁴—, —NR¹²—, —NR¹²—NR¹³, —N(NR¹²R¹³)—, —PR¹²—, —P(O)R¹²—, —O—, —CO—, —CR¹²R¹³—O—, —CR¹²R¹³—S—, —S—, —SO—, —SO₂—, —L¹R¹²R¹³—, —L¹R¹²R¹³— L²R¹⁴R¹⁵—, —L¹R¹²R¹³—L²R¹⁴R¹⁵—L³R¹⁶R¹⁷—, —L¹R¹²R¹³—CR¹⁵, —L¹R¹²R¹³—NR¹⁴—, —L¹R¹²R¹³—O— and —L¹R¹²R¹³—S—, wherein the variables are defined as above. Here and throughout the whole application, the bonding mentioned first is the bonding to the triazole group while the last mentioned bonding connects to the unsaturated fragment.

Preferably, R¹², R¹³, R¹⁴, R¹⁵, and R¹⁷ are each, independently of one another, hydrogen, C₁-C₂₀-alkyl, C₂-C₂₀-alkenyl, C₆-C₂₂-aryl, alkylaryl or alkylaryl having from 1 to 10 carbon atoms in the alkyl part and 6-22 carbon atoms in the aryl part, OR¹⁸ or SiR¹⁸₃, wherein the organic radicals R¹², R¹³, R¹⁴, R¹⁵, R¹⁶, and R¹⁷ may also be substituted by halogens and two vicinal radicals R¹²-R¹⁷ may also be joined to form a five- or six-membered ring and the radicals R¹⁸ are each independently of one another, hydrogen, C₁-C₂₀-alkyl, C₂-C₂₀-alkenyl, C₆-C₂₂-aryl or alkylaryl having from 1 to 10 carbon atoms in the alkyl part and 6-22 carbon atoms in the aryl part, and two radicals R¹⁸ may also be joined to form a five-, six-, or seven-membered ring.

The bridge Z (n=1) between the triazole group and the unsaturated fragment of the substituent is preferably selected from —CR¹²R¹³—CR¹⁴R¹⁵—, —CR¹²R¹³—CR¹⁴R¹⁵—CR¹⁶R¹⁷—, —CR¹²═CR¹³—, —CR¹²R¹³—CO—, —CR¹²R¹³—CR¹⁴R¹⁵—CO—, —CR¹²R¹³—O—, —CR¹²R¹³—S—, —CR¹²R¹³—NR¹⁴—, —SiR¹²R¹³—, and —Si¹R¹²—NR¹⁴—, —Si¹R¹²R¹³—O— and —Si¹R¹²R¹³—S—.

Possible carboorganic substituents R¹², R¹³, R¹⁴, R¹⁵, R¹⁶, and R¹⁷ on the linkage Z are, for example, the following: hydrogen, C₁-C₂₀-alkyl which may be linear or branched, e.g. methyl, ethyl, n-propyl, isopropyl, n-butyl, isobutyl, tert-butyl, n-pentyl, n-hexyl, n-heptyl, n-octyl, n-nonyl, n-decyl or n-dodecyl, 5- to 7-membered cycloalkyl which may in turn bear a C₆-C₁₀-aryl group as substituent, e.g. cyclopropyl, cyclobutyl, cyclopentyl, cyclohexyl, cycloheptyl, cyclooctyl, cyclononyl or cyclododecyl, C₂-C₂₀-alkenyl which may be linear, cyclic or branched and in which the double bond may be internal or terminal, e.g. vinyl, 1-allyl, 2-allyl, 3-allyl, butenyl, pentenyl, hexenyl, cyclopentenyl, cyclohexenyl, cyclooctenyl or cyclooctadienyl, C₆-C₂₂-aryl which may be substituted by further alkyl groups, e.g. phenyl, naphthyl, biphenyl, anthranyl, o-, m-, p-methylphenyl, 2,3-, 2,4-, 2,5- or 2,6-dimethylphen-1-yl, 2,3,4-, 2,3,5-, 2,3,6-, 2,4,5-, 2,4,6- or 3,4,5-trimethylphen-1-yl, or arylalkyl which may be substituted by further alkyl groups, e.g. benzyl, o-, m-, p-methylbenzyl, 1- or 2-ethylphenyl, where two vicinal radicals from R¹², R¹³, R¹⁴, R¹⁵, and R¹⁷ may also be joined to form a 5- or 6-membered ring, for example cyclohexane, and the organic radicals R¹², R¹³, R¹⁴, R¹⁵, R¹⁶, and R¹⁷ may also be substituted by halogens such as fluorine, chlorine or bromine, for example pentafluorophenyl or bis-3,5-trifluoromethylphen-1-yl.

The radicals R¹⁸ in organosilicon substitutents SiR¹⁸₃ can be the same radicals as mentioned above for R¹² to R¹⁷, where two radicals R¹⁸ may also be joined to form a 5- or 6-membered ring, e.g. trimethylsilyl, triethylsilyl, butyldimethylsilyl, tributylsilyl, tritert-butylsilyl, triallylsilyl, triphenylsilyl or dimethylphenylsilyl.

Particularly preferred substituents R¹² to R¹⁷ are hydrogen, C₁-C₂₀-alkyl which may be linear or branched, e.g. methyl, ethyl, n-propyl, isopropyl, n-butyl, isobutyl, tert-butyl, n-pentyl, n-hexyl, n-heptyl, n-octyl, n-nonyl, n-decyl or n-dodecyl, C₆-C₂₂-aryl which may be substituted by further alkyl groups, e.g. phenyl, naphthyl, biphenyl, anthranyl, o-, m-, p-methylphenyl, 2,3-, 2,4-, 2,5- or 2,6-dimethylphen-1-yl, 2,3,4-, 2,3,5-, 2,3,6-, 2,4,5-, 2,4,6- or 3,4,5-trimethylphen-1-yl, or arylalkyl which may be substituted by further alkyl groups, e.g. benzyl, o-, m-, p-methylbenzyl, 1- or 2-ethylphenyl where two radicals R¹² to R¹⁷ may also be joined to form a 5- or 6-membered ring, for example cyclohexane, and the organic radicals R¹² to R¹⁷ may also be substituted by halogens such as fluorine, chlorine or bromine, in particular fluorine, for example pentafluorophenyl or bis-3,5-trifluoromethylphen-1-yl. Particular preference is given to methyl, ethyl, 1-propyl, 2-isopropyl, 1-butyl, 2-tert-butyl, phenyl and pentafluorophenyl.

Z is in particular —CR¹²R¹³—CR¹²R¹³—O—, —CR¹²R¹³—S—, or —CR¹²R¹³—NR¹⁴—, wherein R¹², R¹³, and R¹⁴ are each, hydrogen, C₁-C₂₀-alkyl which may be linear or branched, C₆-C₂₂-aryl which may be substituted by further alkyl groups, wherein two radicals R¹² to R¹⁷ may also be substituted by halogens. Special preference is given to —CR¹²R¹³— being a —CHR¹²—, —CH₂— or —C(CH₃)₂— group. Most preferred is Z being CH₂.

The index n is 0 or 1. The case n being 0 means, that a single bond is formed between the triazole group and the unsaturated fragment of the substituent. In case of n being 1 a bridge is formed between the triazole group and the unsaturated fragment.

R^{A} and R^{B} are identical or different and are each hydrogen or an organic radical having from 1 to 40 carbon atoms which may also contain heteroatoms selected from the group consisting of Si, N, O, and S and may be substituted by one or more halogen atoms. The radicals R^{A} and R^{B} may also form a monocyclic or polycyclic, substituted or unsubstituted ring system which has from 6 to 40 carbon atoms.

Preferably R^{A}, and R^{B} are the same or different and each selected from hydrogen, C₁-C₂₀-alkyl, C₂-C₂₀-alkenyl, C₆-C₂₂-aryl, arylalkyl or alkylaryl having from 1 to 10 carbon atoms in the alkyl radicals and 6-22 carbon atoms in the aryl radical, heteroaryl having from 2 to 21 carbon atoms and from 1 to 3 heteroatoms selected from N, S, and O, heteroarylalkyl or alkylheteroaryl having from 1 to 10 carbon atoms in the alkyl radicals and from 2 to 21 carbon atoms and from 1 to 3 heteroatoms selected from N, S, and O in the aryl radical, and OR⁷, SR⁷, NR⁷₂, SiR⁸₃, where the organic radicals R^{A} and R^{B} may also be substituted by halogens and/or the vicinal radicals R^{A} and R^{B} may also be joined to form a five-, six- or seven-membered ring and/or the vicinal radicals R^{A} and R^{B} may be joined to form a five-, six- or seven-membered heterocycle comprising at least one atom from the group consisting of N, O and S.

Preferably R^{A} and R^{B} together with the unsaturated bond form an aromatic or aliphatic substituted or unsubstituted ring system, e.g. cyclohexen, cyclopenten, cyclohepten, phenyl, methylphenyl, thiophene, pyridine, pyrazine, isoxazole, pyrrazole, pyrrole, furan, thiazole, oxazole, imidazole, isothiazole, oxadiazole, triazole, and benzo-fused analogues of these rings, such as indole, carbazole, benzofuran, benzothiophene and the like, where the organic radicals R^{A} and R^{B} may also be substituted by halogens, such as fluorine, chlorine or bromine.

The radicals R⁷ are each, independently of one another, hydrogen, C₁-C₂₀-alkyl, C₂-C₂₀-alkenyl, C₅-C₂₂-aryl, alkylaryl having from 1 to 10 carbon atoms in the alkyl radical and 6-22 carbon atoms in the aryl radical, heteroaryl having from 2 to 21 carbon atoms and from 1 to 3 heteroatoms selected from N, S, and O, heteroarylalkyl or alkylheteroaryl having from 1 to 10 carbon atoms in the alkyl radicals and from 2 to 21 carbon atoms and from 1 to 3 heteroatoms selected from N, S, and O in the aryl radical, SiR⁸₃, where the organic radicals R⁷ may also be substituted by halogens or nitrogen- and oxygen-comprising groups and two radicals R⁷ may also be joined to form a five- or six-membered ring. Especially preferably R⁷ is C₁-C₂₀-alkyl, C₂-C₂₀-alkenyl, or C₆-C₂₂-aryl.

The radicals R⁸ are each, independently of one another, hydrogen, C₁-C₂₀-alkyl, C₂-C₂₀-alkenyl, C₆-C₂₂-aryl, alkylaryl having from 1 to 10 carbon atoms in the alkyl radical and 6-22 carbon atoms in the aryl radical, heteroaryl having from 2 to 21 carbon atoms and from 1 to 3 heteroatoms selected from N, S, and O, heteroarylalkyl or alkylheteroaryl having from 1 to 10 carbon atoms in the alkyl radicals and from 2 to 21 carbon atoms and from 1 to 3 heteroatoms selected from N, S, and O in the aryl radical, where the organic radicals R⁸ may also be substituted by halogens or nitrogen- and oxygen-comprising groups and two radicals R⁸ may also be joined to form a five- or six-membered ring. Especially preferably R⁸ is C₁-C₂₀-alkyl, C₂-C₂₀-alkenyl, or C₆-C₂₂-aryl.

R⁵ and R⁶ are identical or different and are each hydrogen or an organic radical having from 1 to 40 carbon atoms which may also contain heteroatoms selected from N, O, and S and may be substituted by halogens.

Preferably R⁵ and R⁶ are the same or different and each selected from hydrogen, C₁-C₂₀-alkyl, C₂-C₂₀-alkenyl, C₆-C₂₂-aryl, arylalkyl or alkylaryl having from 1 to 10 carbon atoms in the alkyl radicals and 6-22 carbon atoms in the aryl radical, heteroaryl having from 2 to 21 carbon atoms and from 1 to 3 heteroatoms selected from N, S, and O, heteroarylalkyl or alkylheteroaryl having from 1 to 10 carbon atoms in the alkyl radicals and from 2 to 21 carbon atoms and from 1 to 3 heteroatoms selected from N, S, and O in the aryl radical, and OR⁷, NR⁷₂, SiR⁸₃, where the organic radicals R⁵ and R⁶ may also be substituted by halogens.

Possible carboorganic substituents R⁵, and R⁶ on the triazole ring are, for example, the following: hydrogen, C₁-C₂₀-alkyl which may be linear or branched, e.g. methyl, ethyl, n-propyl, isopropyl, n-butyl, isobutyl, tert-butyl, n-pentyl, n-hexyl, n-heptyl, n-octyl, n-nonyl, n-decyl or n-dodecyl, 5- to 7-membered cycloalkyl which may in turn bear a C₆-C₁₀-aryl group as substituent, e.g. cyclopropyl, cyclobutyl, cyclopentyl, cyclohexyl, cycloheptyl, cyclooctyl, cyclononyl or cyclododecyl, C₂-C₂₀-alkenyl which may be linear, cyclic or branched and in which the double bond may be internal or terminal, e.g. vinyl, 1-allyl, 2-allyl, 3-allyl, butenyl, pentenyl, hexenyl, cyclopentenyl, cyclohexenyl, cyclooctenyl or cyclooctadienyl, C₆-C₂₂-aryl which may be substituted by further alkyl groups, e.g. phenyl, naphthyl, biphenyl, anthranyl, o-, m-, p-methylphenyl, 2,3-, 2,4-, 2,5- or 2,6-dimethylphen-1-yl, 2,3,4-, 2,3,5-, 2,3,6-, 2,4,5-, 2,4,6- or 3,4,5-trimethylphen-1-yl, or arylalkyl which may be substituted by further alkyl groups, e.g. benzyl, o-, m-, p-methylbenzyl, 1- or 2-ethylphenyl.

Possible R⁵ and R⁶ may also be C₂-C₂₁-heteroaryl comprising from 1 to 3 heteroatoms which may be substituted by further alkyl groups, e.g. pyrrolyl, pyridinyl, triazolyl, thiophenyl, furanyl, isoxazolyl, oazolyl, indalyl, etc., heteroarylalkyl which may be substituted by further alkyl or aryl groups, e.g. pyrrolylmethyl, 1,2,3-trimethylpyrrolyl, 1- or 2-ethylpyridinyl, or phenyltriazolyl, which may also be substituted by halogens such as fluorine, chlorine or bromine, for example pentafluorophenyl or bis-3,5-trifluoromethylphen-1-yl.

Especial preference is given to R⁵ being selected from hydrogen, C₁-C₂₀-alkyl radicals, C₆-C₂₂-aryl radicals, and C₇-C₂₂-arylalkyl radicals, and R⁶ being selected from C₁-C₂₀-alkyl radicals, C₆-C₂₂-aryl radicals, and arylalkyl or alkylaryl having from 1 to 10 carbon atoms in the alkyl radicals and 6-22 carbon atoms in the aryl radical. Especially preferred examples for R⁵ are hydrogen and a phenyl radical. Especially preferred examples for R⁶ are methyl, ethyl, n-propyl, n-butyl, n-pentyl, benzyl, phenyl and substituted phenyl, e.g. trimethylphenyl.

The radicals X are identical or different, preferably identical, and are each a halogen or an organic radical having from 1 to 40 carbon atoms, with two organic radicals X also being able to be joined to one another. X is preferably C₁-C₂₀-alkyl, C₂-C₂₀-alkenyl, C₆-C₂₂-aryl, arylalkyl or alkylaryl having from 1 to 10 carbon atoms in the alkyl radicals and 6-22 carbon atoms in the aryl radical, —OR¹⁰ or —NR¹⁰R¹¹, where two radicals X may also be joined to one another. It is also possible for two radicals X to form a substituted or unsubstituted diene ligand, in particular a 1,3-diene ligand. The radicals R¹⁰ and R¹¹ are each C₁-C₂₀-alkyl, C₆-C₂₂-aryl, arylalkyl or alkylaryl having from 1 to 10 carbon atoms in the alkyl radicals and 6-22 carbon atoms in the aryl radical. Most preferably X are identical and each an aryl or arylalkyl radical, especially a benzyl radical.

The index m is either 1 or 2 and o is 0, 1, 2 or 3 under the provision that m+o=2, 3, or 4. The number is dependent on the oxidation number of M with respect to the carbanionic bond between M and the aryl fragment. E.g. in case of Cr(II) m+o is 2, in case of Cr(III) m+o is 3 and in the case of Zr and Hf m+o=4.

R¹, R², R³, R⁴ are identical or different and are each hydrogen or an organic radical having from 1 to 40 carbon atoms which may also contain heteroatoms selected from the group consisting of Si, N, O, and S and may be substituted by one or more halogen atoms. Two vicinal radicals R¹, R², R³, and R⁴ may also form a monocyclic or polycyclic, substituted or unsubstituted ring system which has from 6 to 40 carbon atoms.

Preferably R¹, R², R³, and R⁴ are the same or different and each selected from hydrogen, C₁-C₂₀-alkyl, C₂-C₂₀-alkenyl, C₆-C₂₂-aryl, arylalkyl or alkylaryl having from 1 to 10 carbon atoms in the alkyl radicals and 6-22 carbon atoms in the aryl radical, heteroaryl having from 2 to 21 carbon atoms and from 1 to 3 heteroatoms selected from N, S, and O, heteroarylalkyl or alkylheteroaryl having from 1 to 10 carbon atoms in the alkyl radicals and from 2 to 21 carbon atoms and from 1 to 3 heteroatoms selected from N, S, and O in the aryl radical, and OR⁷, NR⁷₂, SiR⁸₃, where the organic radicals R¹, R², R³, and R⁴ may also be substituted by halogens and/or vicinal radicals R¹, R², R³, and R⁴ may also be joined to form a five-, six- or seven-membered ring and/or two vicinal radicals R¹, R², R³, and R⁴ may be joined to form a five-, six- or seven-membered heterocycle comprising at least one atom from the group consisting of N, O and S.

Possible carboorganic substituents R¹, R², R³, and R⁴ on the phenyl ring are, for example, the following: hydrogen, C₁-C₂₀-alkyl which may be linear or branched, e.g. methyl, ethyl, n-propyl, isopropyl, n-butyl, isobutyl, tert-butyl, n-pentyl, n-hexyl, n-heptyl, n-octyl, n-nonyl, n-decyl or n-dodecyl, 5- to 7-membered cycloalkyl which may in turn bear a C₆-C₁₀-aryl group as substituent, e.g. cyclopropyl, cyclobutyl, cyclopentyl, cyclohexyl, cycloheptyl, cyclooctyl, cyclononyl or cyclododecyl, C₂-C₂₀-alkenyl which may be linear, cyclic or branched and in which the double bond may be internal or terminal, e.g. vinyl, 1-allyl, 2-allyl, 3-allyl, butenyl, pentenyl, hexenyl, cyclopentenyl, cyclohexenyl, cyclooctenyl or cyclooctadienyl, C₆-C₂₂-aryl which may be substituted by further alkyl groups, e.g. phenyl, naphthyl, biphenyl, anthranyl, o-, m-, p-methylphenyl, 2,3-, 2,4-, 2,5- or 2,6-dimethylphen-1-yl, 2,3,4-, 2,3,5-, 2,3,6-, 2,4,5-, 2,4,6- or 3,4,5-trimethylphen-1-yl, or arylalkyl which may be substituted by further alkyl groups, e.g. benzyl, o-, m-, p-methylbenzyl, 1- or 2-ethylphenyl.

R¹, R², R³, and R⁴ may also be C₂-C₂₁-heteroaryl comprising from 1 to 3 heteroatoms which may be substituted by further alkyl groups, e.g. pyrrolyl, pyridinyl, triazolyl, thiophenyl, furanyl, isoxazolyl, oazolyl, indalyl, etc., heteroarylalkyl which may be substituted by further alkyl or aryl groups, e.g. pyrrolylmethyl, 1,2,3-trimethylpyrrolyl, 1- or 2-ethylpyridinyl, or phenyltriazolyl. Two vicinal radicals from R¹, R², R³, and R⁴ may be joined to form a ring, for example cyclohexane, and the organic radicals R¹, R², R³, and R⁴ may also be substituted by halogens such as fluorine, chlorine or bromine, for example pentafluorophenyl or bis-3,5-trifluoromethylphen-1-yl.

Especially preferred is that R¹ and R³ are the same and selected from hydrogen, C₁-C₁₀-alkyl, C₂-C₁₀-alkenyl, C₅-C₁₀-aryl, arylalkyl or alkylaryl having from 1 to 10 carbon atoms in the alkyl part and 5-10 carbon atoms in the aryl part, NR⁷₂, SiR⁸₃, or OR⁸ where the organic radicals R¹ and R³ may also be substituted by halogens, preferably fluorine, and R² and R⁴ are each hydrogen.

Furthermore, the substituents according to the present invention are, unless restricted further, defined as follows:

The term “unsaturated fragment” as used in this context, refers to an unsubstituted or substituted, two carbon atoms comprising radical, wherein the two carbon atoms are connected by a double bond. The term also includes the case when the two carbon atoms are connected by am aromatic bond, i.e. are part of an aromatic system.

The term “organic radical having from 1 to 40 carbon atoms”; as used in the present context refers to, for example, C₁-C₄₀-alkyl radicals, C₁-C₁₀-fluoroalkyl radicals, C₁-C₁₂-alkoxy radicals, saturated C₃-C₂₀-heterocyclic radicals, C₆-C₄₀-aryl radicals, C₂-C₄₀-heteroaromatic radicals, C₆-C₁₀-fluoroaryl radicals, C₆-C₁₀-aryloxy radicals, C₃-C₁₈-trialkylsilyl radicals, C₂-C₂₀-alkenyl radicals, C₂-C₂₀-alkynyl radicals, C₇-C₄₀-arylalkyl radicals or C₈-C₄₀-arylalkenyl radicals.

The term “alkyl” as used in the present context encompasses linear or singly or multiply branched saturated hydrocarbons, which may also be cyclic. Preference is given to C₁-C₁₈-alkyl such as methyl, ethyl, n-propyl, n-butyl, n-pentyl, n-hexyl, n-heptyl, n-octyl, n-nonyl, n-decyl, cyclopentyl, cyclohexyl, isopropyl, isobutyl, isopentyl, isohexyl, sec-butyl or tert-butyl.

The term “alkenyl” as used in the present context encompasses linear or singly or multiply branched hydrocarbons having at least one C—C double bond, if desired a plurality of C—C double bonds, which may be cumulated or alternating.

The term “aryl” as used in the present context refers, for example, to aromatic and fused or unfused polyaromatic hydrocarbon substituents which may be monosubstituted or polysubstituted by linear or branched C₁-C₁₈-alkyl, C₁-C₁₈-alkoxy, C₂-C₁₀-alkenyl or halogen, in particular fluorine. Preferred examples of substituted and substituted aryl radicals are, in particular, phenyl, pentafluorophenyl, 4-methylphenyl, 4-ethylphenyl, 4-n-propylphenyl, 4-isopropylphenyl, 4-tert-butylphenyl, 4-methoxyphenyl, 1-naphthyl, 9-anthryl, 9-phenanthryl, 3,5-dimethylphenyl, 3,5-di-tert-butylphenyl or 4-trifluoromethylphenyl.

The term “heteroaryl” refers to an aryl radical that includes one or more heteroatoms N, O, S in the aromatic ring. Specific heteroaryl groups include groups containing heteroaromatic rings such as thiophene, pyridine, pyrazine, isoxazole, pyrrazole, pyrrole, furan, thiazole, oxazole, imidazole, isothiazole, oxadiazole, triazole, and benzo-fused analogues of these rings, such as indole, carbazole, benzofuran, benzothiophene and the like.

The term “arylalkyl” as used in the present context refers, for example, to aryl-containing substituents whose aryl radical is linked via an alkyl chain to the remainder of the molecule. Preferred examples are benzyl, substituted benzyl, phenethyl, substituted phenethyl and the like.

The term “halogen” is used in the conventional sense to refer to a chloro, bromo, fluoro or iodo radical.

The term “containing heteratoms selected from N, O or S” refer to a molecule or molecular fragment in which one or more carbon atoms is replaced with a heteroatom. Thus, for example, in view of “alkyl” it refers to an alkyl substituent that is heteroatom-containing. In respect of “cycles” containing a heteroatom one or more carbon atoms in a ring is replaced with a heteroatom—that is, an atom other than carbon, i.e. nitrogen, oxygen, sulfur, phosphorus.

Illustrative examples of novel organometallic transition metal compounds of the formula (I), which do not, however, restrict the scope of the invention, are:

Examples for suitable ligands are as follows:

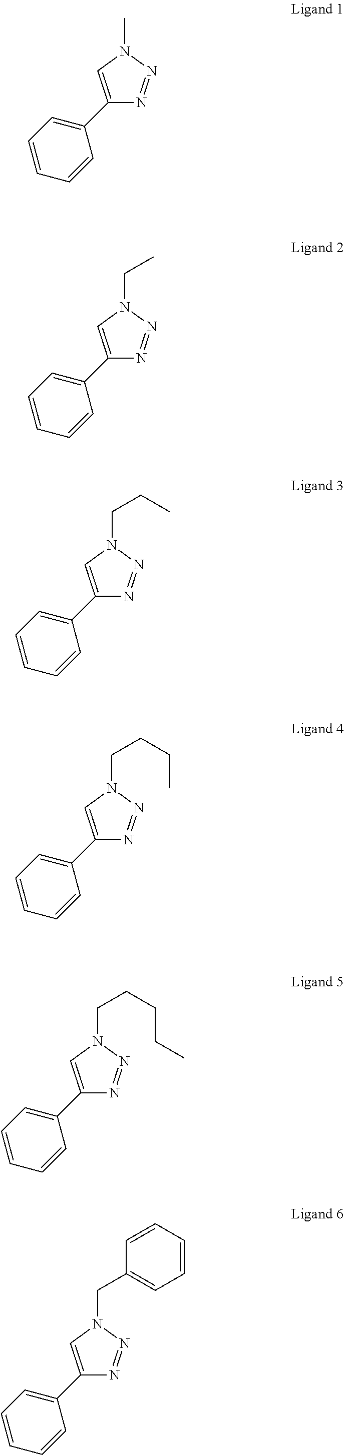

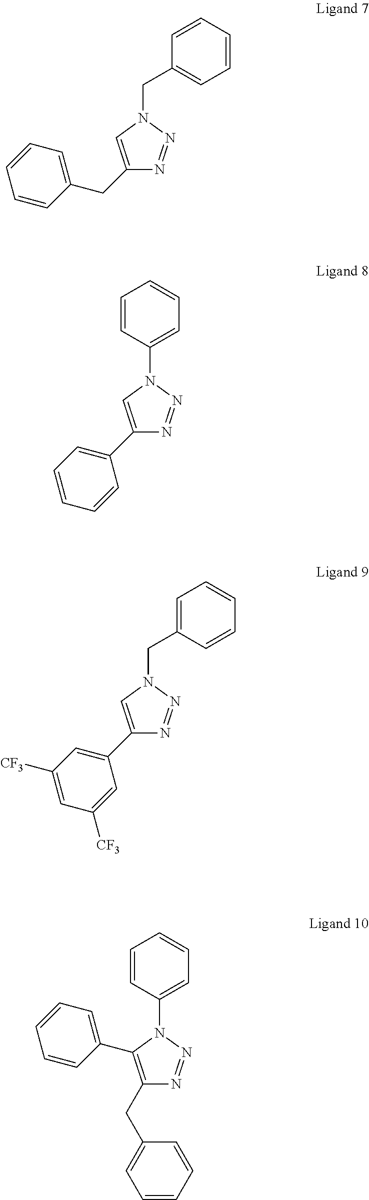

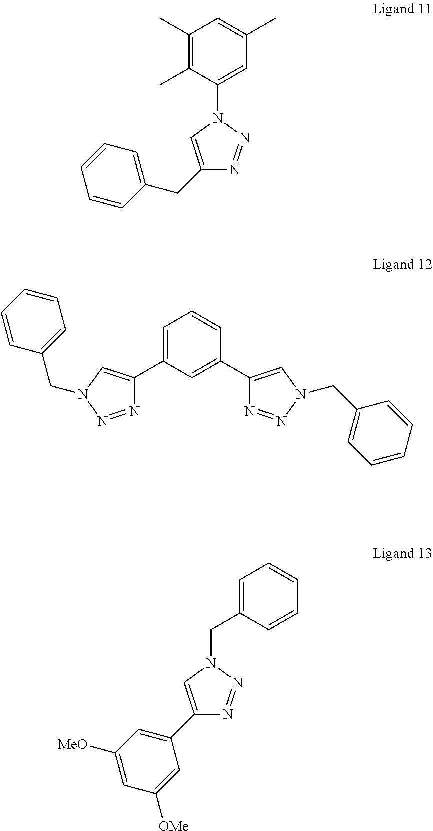

The ligands preferably are made by synthesis of triazole backbones using a “one pot” fashion. Preparation methods are described in Synthesis 2008, No. 3, 363-368 and Organic Letters 2007, Vol. 9, No. 9, 1809-1811.

In reference to Synthesis 2008, No. 3, 363-3683 the ligand is produced as follows:

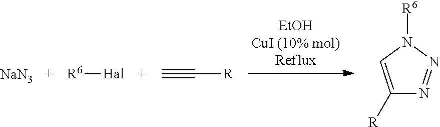

The mono-anionic site is a carbanion (C—H activation) derived from the 4-aryl substituent.

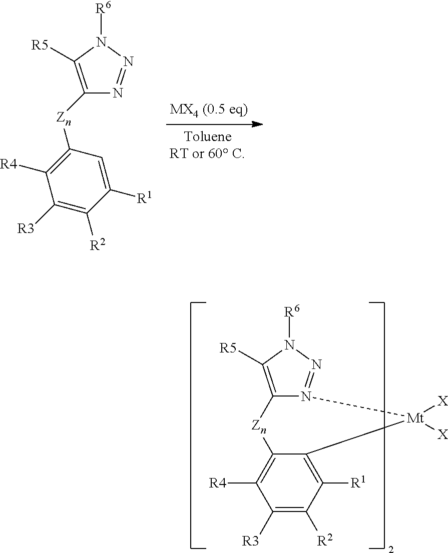

The general preparation comprises stirring a mixture of a triazole-based ligand, MX₄ and toluene is stirred 15 h at 60° C. or 3-4 days at ambient temperature. Within the time, the reaction mixture turns into a dark red solution and to a suspension. The obtained suspension is filtered, washed with toluene and dried under high vacuum.

The transition metal complexes of the present invention can be used alone or together with further components as catalyst system for olefin polymerization. We have also found catalyst systems for olefin polymerization comprising

A) at least one transition metal complex according to the present invention,
B) one or more activating compounds or cocatalysts,
C) optionally an organic or inorganic support.
D) optionally one or more metal compounds containing a metal of group 1, 2 or 13 of the Periodic Table.

For the transition metal complexes of the present invention to be able to be used in polymerization processes in the gas phase or in suspension, it is often advantageous for them to be used in the form of a solid, i.e. for them to be applied to a solid support C). This enables, for example, deposits in the reactor to be avoided and the polymer morphology to be controlled. As support materials, preference is given to using silica gel, magnesium chloride, aluminum oxide, mesoporous materials, aluminosilicates, hydrotalcites and organic polymers such as polyethylene, polypropylene, polystyrene, polytetrafluoroethylene or polymers bearing polar functional groups, for example copolymers of ethene and acrylic esters, acrolein or vinyl acetate.

As support component B), preference is given to using finely divided supports which can be any organic or inorganic solid. In particular, the support component B) can be a porous support such as talc, a sheet silicate such as montmorillonite, mica, an inorganic oxide or a finely divided polymer powder (e.g. polyolefin or a polymer bearing polar functional groups).

As solid support materials C) for catalysts for olefin polymerization, preference is given to using silica gels since particles whose size and structure make them suitable as supports for olefin polymerization can be produced from this material. Spray-dried silica gels comprising spherical agglomerates of smaller granular particles, i.e. primary particles, have been found to be particularly useful. The silica gels can be dried and/or calcined before use. Further preferred supports C) are hydrotalcites and calcined hydrotalcites.

The transition metal complexes of the present invention often have little polymerization activity on their own and are then brought into contact with an activator, viz. the component B), to be able to display good polymerization activity. For this reason, the catalyst system optionally further comprises, as component B), one or more activating compounds or cocatalysts, preferably at least one cation-forming compound B).

Suitable compounds B) which are able to react with the transition metal complex A) to convert it into a catalytically active, or more active, compound are, for example, compounds such as an aluminoxane, a strong uncharged Lewis acid, an ionic compound having a Lewis-acid cation or an ionic compound containing a Brönsted acid as cation.

As aluminoxanes, it is possible to use, for example, the compounds described in WO 00/31090. A particularly useful aluminoxane compound is methylaluminoxane. These oligomeric aluminoxane compounds are usually prepared by controlled reaction of a solution of trialkylaluminum with water. In general, the oligomeric aluminoxane compounds obtained in this way are in the form of mixtures of both linear and cyclic chain molecules of various lengths, so that I is to be regarded as a mean. The aluminoxane compounds can also be present in admixture with other metal alkyls, usually aluminum alkyls. Aluminoxane preparations suitable as component B) are commercially available.

Furthermore, modified aluminoxanes in which some of the hydrocarbon radicals have been replaced by hydrogen atoms or alkoxy, aryloxy, siloxy or amide radicals can also be used as component B) in place of the above described aluminoxane compounds.

It has been found to be advantageous to use the transition metal complexes A) and the aluminoxane compounds in such amounts that the atomic ratio of aluminum from the aluminoxane compounds including any aluminum alkyl still present to the transition metal from the complex A) is in the range from 1:1 to 1 000:1, preferably from 10:1 to 500:1 and in particular in the range from 20:1 to 400:1.

Examples for strong, uncharged Lewis acids are given in WO 00/31090. Compounds of this type, which are particularly useful as cocatalyst B), are boranes and boroxins, such as trialkylborane, triarylborane, or trimethylboroxin. Particular preference is given to using boranes which bear at least two perfluorinated aryl radicals, e.g. tris(pentafluorophenyl)borane. Examples for further suitable aluminum and boron compounds are boronic acids and borinic acids, in particular borinic acids having perfluorinated aryl radicals, for example (C₆F₅)₂BOH.

Strong uncharged Lewis acids suitable as activating compounds B) also include the reaction products of a boronic acid with two equivalents of an aluminum trialkyl or the reaction products of an aluminum trialkyl with two equivalents of an acidic fluorinated, in particular perfluorinated, hydrocarbon compound such as pentafluorophenol or bis(pentafluorophenyl)borinic acid.

Suitable ionic compounds having Lewis acid cations include salt-like compounds such as carbonium cations, oxonium cations and sulfonium cations and also cationic transition metal complexes. Particular mention may be made of the triphenylmethyl cation, the silver cation and the 1,1′-dimethylferrocenyl cation. They preferably have noncoordinating counterions, in particular boron compounds as are also mentioned in WO 91/09882, preferably tetrakis(pentafluorophenyl)borate.

Salts having noncoordinating anions can also be prepared by combining a boron or aluminum compound, e.g. an aluminum alkyl, with a second compound which can react to link two or more boron or aluminum atoms, e.g. water, and a third compound which forms an ionizing ionic compound with the boron or aluminum compound, e.g. triphenylchloromethane, or optionally a base, preferably an organic nitrogen-containing base, for example an amine, an aniline derivative or a nitrogen heterocycle. In addition, a fourth compound which likewise reacts with the boron or aluminum compound, e.g. pentafluorophenol, can be added.

Ionic compounds containing Brönsted acids as cations preferably likewise have noncoordinating counterions. As Brönsted acid, particular preference is given to protonated amine or aniline derivatives. Preferred cations are N,N-dimethylanilinium, N,N-dimethylcyclohexylammonium and N,N-dimethylbenzylammonium and also derivatives of the latter two.

Compounds containing anionic boron heterocycles as are described in WO 97/36937 A1 are also suitable as cocatalyst B), in particular dimethylanilinium boratabenzene or trityl boratabenzene.

Preferred ionic compounds B) comprise borates which bear at least two perfluorinated aryl radicals. Particular preference is given to N,N-dimethylanilinium tetrakis(pentafluorophenyl)borate and in particular N,N-dimethylcyclohexylammonium tetrakis(pentafluorophenyl)borate, N,N-dimethylbenzylammonium tetrakis(pentafluorophenyl)borate or trityl tetrakispentafluorophenylborate.

It is also possible for two or more borate anions and/or boranes to be joined to one another or for a borate anion to be joined to a borane, as in the dianion [(C₆F₅)₃B—C₆F₄—B(C₆F₅)₃]²⁻ or the anion [(C₆F₅)₃B—CN—B(C₆F₅)₃], or the borate anion can be bound via a bridge bearing a suitable functional group to the support surface.

The amount of strong, uncharged Lewis acids, ionic compounds having Lewis-acid cations or ionic compounds containing Brönsted acids as cations is preferably from 0.1 to 20 equivalents, more preferably from 1 to 10 equivalents, based on the complex A).

Suitable activating compounds B) also include boron-aluminum compounds such as di[bis(pentafluorophenyl)boroxy]methylalane. Examples of such boron-aluminum compounds are those disclosed in WO 99/06414 A1.

Both the complex A) and the activating compound(s) B) are preferably used in a solvent, preferably an aromatic hydrocarbon having from 6 to 20 carbon atoms, in particular xylenes, toluene, pentane, hexane, heptane or a mixture thereof.

The catalyst system may further comprise, as additional component D), a metal compound, such as

methyllithium, ethyllithium, n-butyllithium, methylmagnesium chloride, methylmagnesium bromide, ethylmagnesium chloride, ethylmagnesium bromide, butylmagnesium chloride, dimethylmagnesium, diethylmagnesium, dibutylmagnesium, n-butyl-n-octylmagnesium, n-butyl-n-heptylmagnesium, in particular n-butyl-n-octylmagnesium, tri-n-hexylaluminum, triisobutylaluminum, tri-n-butylaluminum, triethylaluminum, dimethylaluminum chloride, dimethylaluminum fluoride, methylaluminum dichloride, methylaluminum sesquichloride, diethylaluminum chloride and trimethylaluminum and mixtures thereof. The partial hydrolysis products of aluminum alkyls with alcohols can also be used.

To prepare the catalyst systems of the present invention, preference is given to immobilizing at least one of the components A) and/or B) on the support C) by physisorption or by means of chemical reaction, i.e. covalent binding of the components, with reactive groups of the support surface. The order in which the support component C), the component A) and any component B) are combined is immaterial. The components A) and C) can be added independently of one another or simultaneously or in premixed form to C). After the individual process steps, the solid can be washed with suitable inert solvents such as aliphatic or aromatic hydrocarbons.

The catalyst of the present invention is useful in polymerization and copolymerization of olefins, especially ethene and α-olefins having from 3 to 12 carbon atoms. The α-olefins having from 3 to 12 carbon atoms are preferably in particular linear C₃-C₁₀-1-alkenes such as propene, 1-butene, 1-pentene, 1-hexene, 1-heptene, 1-octene, 1-decene or branched C₃-C₁₀-1-alkenes such as 4-methyl-1-pentene. It is also possible to polymerize mixtures of various α-olefins.

Preference is given to polymerizing ethylene or copolymerizing ethylene and at least one α-olefin selected from the group consisting of propene, 1-butene, 1-pentene, 1-hexene, 1-heptene, 1-octene and 1-decene. Monomer mixtures containing at least 50 mol % of ethene are preferably used.

The polymerizations are usually carried out at from −60 to 350° C. under pressures of from 0.5 to 4000 bar at mean residence times of from 0.5 to 5 hours. The advantageous pressure and temperature ranges for carrying out the polymerizations usually depend on the polymerization method. In the case of high-pressure polymerization processes, which are usually carried out at pressures of from 1000 to 4000 bar, high polymerization temperatures are generally also set. Advantageous temperature ranges for these high-pressure polymerization processes are from 200 to 320° C. In the case of low-pressure polymerization processes, a temperature which is at least a few degrees below the softening temperature of the polymer is generally set. These polymerization processes are preferably carried out at from 50 to 180° C. In the case of suspension polymerization, the polymerization is usually carried out in a suspension medium, preferably an inert hydrocarbon such as isobutane or a mixture of hydrocarbons, or else in the monomers themselves. The polymerization temperatures are generally in the range from −20 to 115° C., and the pressure is generally in the range from 1 to 100 bar. The solids content of the suspension is generally in the range from 10 to 80%. The polymerization can be carried out batchwise, e.g. in stirring autoclaves, or continuously, e.g. in tube reactors, preferably in loop reactors. The gas-phase polymerization is generally carried out at from 30 to 125° C.

Among the abovementioned polymerization processes, particular preference is given to gas-phase polymerization, in particular in gas-phase fluidized-bed reactors, solution polymerization and suspension polymerization, in particular in loop reactors and stirred tank reactors. The gas-phase polymerization can also be carried out in the condensed or supercondensed phase, in which part of the circulating gas is cooled to below the dew point and is recirculated as a two-phase mixture to the reactor. It is also possible to use a multizone reactor in which two polymerization zones are linked to one another and the polymer is passed alternately through these two zones a number of times. The two zones can also have different polymerization conditions. Such a reactor is described, for example, in WO 97/04015 A1. The different or identical polymerization processes can also, if desired, be connected in series so as to form a polymerization cascade, for example as in the Hostalen process. A parallel reactor arrangement using two or more identical or different processes is also possible. Furthermore, molar mass regulators, for example hydrogen, or customary additives such as antistatics can also be used in the polymerizations.

The following examples merely illustrate the invention. Those skilled in the art will recognize many variations that are within the spirit of the invention and scope of the claims.

### EXAMPLES

Determination of molecular weight (Mw) by gel permeation chromatography: The determination of the molar mass distribution and the mean Mw derived therefrom was carried out by high-temperature gel permeation chromatography using a method described in DIN 55672-1:1995-02 issue February 1995. The deviations according to the mentioned DIN standard are as follows: Solvent 1,2,4-trichlorobenzene (TCB), temperature of apparatus and solutions 135° C. and as concentration detector a PolymerChar (Valencia, Paterna 46980, Spain) IR-4 infrared detector, capable for use with TCB.

A WATERS Alliance 2000 equipped with the following precolumn SHODEX UT-G and separation columns SHODEX UT 806 M (3×) and SHODEX UT 807 connected in series was used. The solvent was vacuum destilled under Nitrogen and was stabilized with 0.025% by weight of 2,6-di-tert-butyl-4-methylphenol. The flowrate used was 1 ml/min, the injection was 500 μl and polymer concentration was in the range of 0.01%<conc.<0.05% w/w. The molecular weight calibration was established by using monodisperse polystyrene (PS) standards from Polymer Laboratories (now Varian, Inc., Essex Road, Church Stretton, Shropshire, SY6 6AX,UK) in the range from 580 g/mol up to 11600000 g/mol and additionally Hexadecane. The calibration curve was then adapted to Polyethylene (PE) by means of the Universal Calibration method (Benoit H., Rempp P. and Grubisic Z., & in J. Polymer Sci., Phys. Ed., 5, 753 (1967)). The Mark-Houwing parameters used herefore were for PS: k_{PS}=0.000121 dl/g, α_{PS}=0.706 and for PE k_{PE}=0.000406 dl/g, α_{PE}=0.725, valid in TCB at 135° C. Data recording, calibration and calculation was carried out using NTGPC_Control_V6.02.03 and NTGPC_V6.4.24 (hs GmbH, Hauptstraβe 36, D-55437 Ober-Hilbersheim) respectively.

Determination of the viscosity number (I.V.):

The viscosity number was determined in an Ubbelohde viscometer PVS 1 fitted with an S 5 measuring head (both from Lauda) in decalin at 135° C. To prepare the sample, 20 mg of polymer were dissolved in 20 ml of decalin at 135° C. for 2 hours. 15 ml of the solution were placed in the viscometer and the instrument carried out a minimum of three running-out time measurements until a consistent result had been obtained. The I.V. was calculated from the running-out times by means of the relationship I.V.=(t/t₀−1)*1/c, where t=mean of the running-out time of the solution, t₀=mean of the running-out time of the solvent, c: concentration of the solution in g/ml.

### Preparation of Triazole Ligands

### Example 1

### Preparation of 1-methyl-4-phenyl-1H-1,2,3-triazole

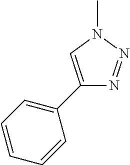

The synthesis of the ligand was performed in analogy to Synthesis 2008, No. 3, 363-368 with the exception that instead of supported Cu(I) a 10% solution of CuI in ethanol was used.

Under an atmosphere of N₂, a two-necked round bottomed flask containing a stirrer bar was charged with iodomethane (1.0 mmol) in ethanol, NaN₃ (1.0 mmol), Ph-C≡CH (1 mmol), and CuI (0.05 mmol, 10% solution in ethanol). The mixture was heated and stirred at 78° C. for 24 h. After cooling to room temperature, the reaction mixture was vacuum-filtered through a sintered-glass funnel and washed with CH₂Cl₂ (5 ml). The combined organic layers were dried (MgSO₄) and evaporated under reduced pressure. The residue was finally purified by flash chromatography (silica gel) to give the desired product as a white powder (30%).

GC/MS: m/z=159, purity>99%

¹H NMR (C₆D₆) δ: 7.95-7.93 (m, 2H), 7.24 (t, J=6.04 Hz, 2H), 7.13-7.10 (m, 1H), 6.58 (s, 1H) and 3.04 (s, 3H).

### Example 2

### Preparation of 1-pentyl-4-phenyl-1H-1,2,3-triazole

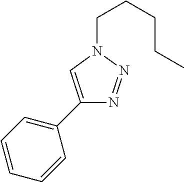

The synthesis was performed according to example 1 with the difference that instead of iodomethane 1-chloropentane was used. This triazole has been isolated as a white powder (38%).

GC/MS: m/z=215, purity>99%

### Example 3

### Preparation of 1-benzyl-4-phenyl-1H-1,2,3-triazole

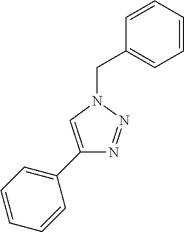

The synthesis was performed according to example 1 with the difference that instead of iodomethane benzylchloride was used. This triazole has been isolated as a white powder in yield of 80%.

GC/MS: m/z=235, purity>99%

¹H NMR (C₆D₆) δ: 7.87-7.85 (m, 2H), 7.19 (t, J=5.92 Hz, 2H), 7.12-7.06 (m, 1H), 7.00-6.97 (m, 3H), 6.90 (s, 1H) 6.85-6.82 (m, 2H) and 4.84 (s, 2H).

### Example 4

### Preparation of 1,4-diphenyl-1H-1,2,3-triazole

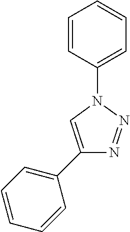

Preparation was performed according to Organic Letters 2007, Vol. 9, No. 9, 1809-1811. This triazole has been isolated as a white powder.

GC/MS: m/z=221, purity>99%

### Example 5

### Preparation of 1-benzyl-4-(3,5-di trifluoromethyl phenyl)-1H-1,2,3-triazole

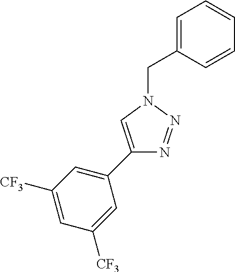

The synthesis was performed according to example 1 with the difference that instead of iodomethane benzylchloride was used and instead of Ph-C≡CH 3,5-di(trifluoro methyl)phenyl —C≡CH was used. This triazole has been isolated as a white powder (75%).

GC/MS: m/z=371, purity>99%

### Example 6

### Preparation of 1,5-diphenyl-4-benzyl-1H-1,2,3-triazole

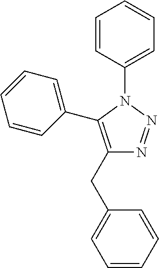

Preparation was performed according to Organic Letters 2007, Vol. 9, No. 12, 2333-2336.

Under an atmosphere of N₂, a two-necked round bottomed flask containing a stirrer bar was charged with 1-benzyl-4-phenyl-1H-1,2,3-triazole (1.0 mmol), Pd(PPh₃)₂Cl₂ (5% mol), and (nBu)₄NOAc. NMP (10 ml) and PhBr (1.5 mmol) were then added. The reaction mixture was stirred at 100° C. for 4 h. After cooling to room temperature, the reaction mixture was diluted with ethyl acetate (20 m), washed with H2O, brine and dried the organic layer was dried (MgSO₄) and evaporated under reduced pressure. The residue was finally purified by flash chromatography (silica gel) to give the desired product as a white powder (52%).

GC/MS: m/z=311, purity>99%

### Example 7

### Preparation of Ligand 7

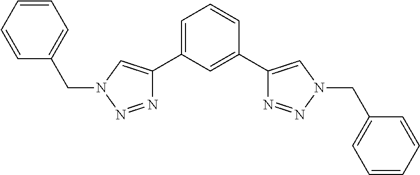

The synthesis was performed according to example 1 with the difference that firstly instead of iodomethane benzylchloride and secondly 2.5 equivalent of both benzylchloride and NaN₃ were used. This triazole has been isolated as a white powder (81%).

¹H NMR (C₆D₆) δ: 8.2 (t, J=1.2 Hz, 1H), 7.81 (s, 2H), 7.77 (dd, J=1.2 Hz and J=6.3 Hz, 2H), 7.45 (t, J=6.3 Hz, 1H), 7.41-7.32 (m, 10H), and 5.57 (s, 4H).

### Preparation of Complexes

### Example 8

### Complex 1

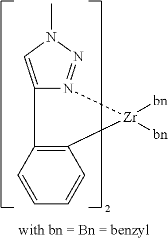

A mixture of a 1-N-methyl 4-phenyl triazole (255 mg, 1.6 mmol, 1 eq) from example 1, ZrBn₄ (365 mg, 0.5 eq) and toluene (15 ml) was stirred 15 h at 60° C. for 15 h. Within the time period the reaction mixture turned into a dark red solution and to a suspension. The obtained suspension was filtered, washed with toluene and dried under high vacuum.

This triazole-based catalyst was isolated as a red powder (reaction done at 60° C.) (28%).

¹H-NMR (THF-d8) δ: 7.92 (s, 2H), 7.33-7.31 (m, 2H), 7.21-7.19 (m, 2H), 6.91 (dt, J=5.90 Hz and J=1.00 Hz, 2H), 6.81 (dt, J=5.90 Hz and J=1.00 Hz, 2H), 6.67-6.64 (m, 4H), 6.53 (d, J=5.64 Hz, 4H), 6.42-6.39 (t, J=5.80 Hz, 2H), 4.15 (s, 6H), and 2.54 (s, 4H).

The aforementioned complex was quenched with D₂O and analyzed by GC/MS and ¹H-NMR too.

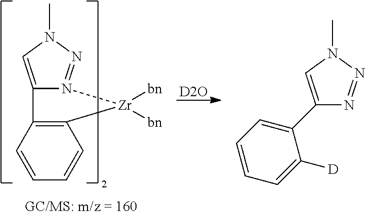

¹H-NMR (C₆D₆) δ: 7.95-7.93 (m, 1H), 7.26-7.23 (m, 2H), 7.12 (dt, J=6.04 Hz and J=1.04 Hz, 1H), 6.58 (s, 1H) and 3.04 (s, 3H).

### Example 9

### Complex 2

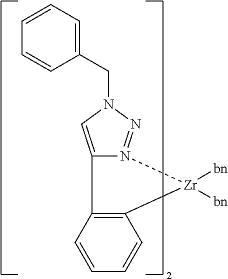

The complex was prepared like in example 8 with the exception that instead of 1 eq. 1-methyl 4-phenyl triazole 1 eq. 1-benzyl 4-phenyl triazole has been used.

This triazole-based catalyst was isolated as a yellow-orange powder (reaction done at 60° C.) (28%).

¹H-NMR (THF-d8) δ: 7.95 (s, 2H), 7.40-7.38 (m, 10H), 7.34-7.32 (m, 2H), 7.25-7.22 (m, 2H), 6.89 (dt, J=5.80 Hz and J=1.00 Hz, 2H), 6.80 (dt, J=5.80 Hz and J=1.00 Hz, 2H), 6.63-6.60 (m, 4H), 6.56 (dd, J=6.4 Hz and J=0.9H, 4H), 6.33 (t, J=5.7 Hz, 2H), 5.65 (s, 4H), and 2.59 (s, 4H).

The quenching step was also done and confirmed the C—H activation.

GC/MS: m/z=236

¹H-NMR (C6D6) δ: 7.86-7.84 (m, 1H), 7.21-7.17 (m, 2H), 7.09 (dt, J=6.04 Hz and J=1.08 Hz, 1H), 6.99-6.97 (m, 3H), 6.88 (s, 1H) 6.83-6.81 (m, 2H) and 4.84 (s, 2H).

### Example 10

### Complex 3

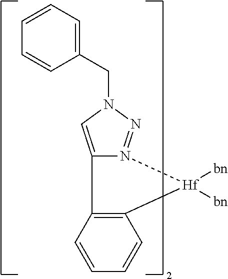

This triazole-based catalyst has been isolated as a yellow powder (reaction done at ambient temperature) (66%). According to ¹H-NMR a mixture of bis adduct-HfBn₂ and mono adduct-HfBn₃ was obtained (55%/45%). Due to these two products, overlapping disturbs the complete ¹H-NMR analysis, therefore only some signals can be without doubt attributed.

¹H-NMR (C₆D₆) of bis adduct δ: 7.74 (d, J=5.36 Hz, 2H), 7.23 (s, 2H, C═CH), 6.56 (d, J=5.92 Hz, 4H), 5.33 (s, 4H), and 2.35 (s, 4H).

### Catalyst System and Polymerization

### Example 11

### 11.1 Catalyst Preparation

To 1.4 ml of MAO solution in toluene (Albemarle; 4.21M, 5.9 mmoles) 0.030 g of trityl tetrakis-pentafluoroborate (Strem Chemicals; 0.033 mmoles) was added and stirred for 15 minutes, followed by addition of 0.027 mmoles of the dry precursor complex of examples 14 and 15, respectively. After 15 minutes the resulting solution was slowly added to a bed of 1 g of Davison 948 silica (calcined for 6 h at 600° C.). The resulting free flowing powder was used in polymerization tests.

### 11.2 Polymerization

A jacketed 21 stainless steel autoclave was charged with 900 ml of isobutene, 100 ml of 1-butene, 1 ml of 1M solution of tri-isobutylaluminum in hexenes and pressurized at 70° C. with ethylene to 15.2 bar partial pressure of ethylene. The polymerization was started by injecting a supported catalyst sample with 100 ml of isobutane. Ethylene was supplied on demand to maintain the 15.2 bar partial pressure of ethylene at 70° C. for 60 minutes (the ethylene consumption curves are presented in the picture). The polymerization was terminated by venting the reactor content and reducing the jacket temperature. The results are shown in the following Table I.

| Pre- | | Poly- | | | | |
|---|---|---|---|---|---|---|
| catalyst of | Zr | merization | Activity | Yield | Mw | |
| example | [mmol] | time [min] | [kg/mol/h] | [g] | [kg/mol] | IV |
| 8 | 0.008489 | 60 | 2.276 | 19.32 | 589 | 16.08 |
| 9 | 0.006748 | 60 | 2.023 | 13.65 | 741 | 16.2 |

1. A transition metal complex comprising a metal of group 3, 4, or 6 of the Periodic Table of the Elements and one, or two mono-anionic, bidentate triazole ligands each having a substituent with an unsaturated fragment, wherein one carbon atom of the unsaturated fragment is bound directly or via a bridge to a triazole group and the other carbon atom is bound to the transition metal.

2. The complex according to claim 1 corresponding to formula I: 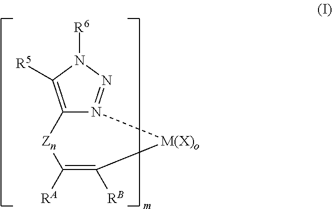
wherein
M is an element of group 3, 4 or 6 of the Periodic Table of the Elements;
Z is a bridge between the triazole group and the unsaturated fragment of the substituent selected from —CR¹²R¹³—, —CR¹²R¹³—CR¹⁴R¹⁵—, —CR¹²R¹³—CR¹⁴R¹⁵—CR¹⁶R¹⁷—, —CR¹²═CR¹³—, —CR¹²R¹³—CO—, —CR¹²R¹³—CR¹⁴R¹⁵—CO—, —CR¹²R¹³—NR¹⁴—, —NR¹²—, —NR¹²—NR¹³—, —N(NR¹²R¹³)—, —PR¹²—, —P(O)R¹²—, —O—, —CO—, —CR¹²R¹³—O—, —CR¹²R¹³—S—, —S—, —SO—, —SO₂—, —L¹R¹²R¹³—, —L¹R¹²R¹³— L²R¹⁴R¹⁵—, —L¹R¹²R¹³—L²R¹⁴R¹⁵—L³R¹⁶R¹⁷—, —L¹R¹²R¹³—CR¹⁴R¹⁵—, —L¹R¹²R¹³—NR¹⁴—, —L¹R¹²R¹³—O— and —L¹R¹²R¹³—S—, wherein L¹-L³ are each, independently of one another, silicon or germanium;
R¹², R¹³, R¹⁴, R¹⁵, R¹⁶, and R¹⁷ are each, independently of one another, hydrogen or an organic radical having from 1 to 40 carbon atoms, or two vicinal radicals selected from R¹², R¹³, R¹⁴, R¹⁵, R¹⁶, and R¹⁷ form a monocyclic or polycyclic, substituted or unsubstituted ring system which has from 6 to 40 carbon atoms, wherein R¹², R¹³, R¹⁴, R¹⁵, R¹⁶, and R¹⁷ may also contain heteroatoms selected from the group consisting of the elements Si, N, O and S and may be substituted by at least one halogen atom;
n is 0 or 1;
R^{A}, R^{B}, R⁵, and R⁶ are identical or different and are each hydrogen or an organic radical having from 1 to 40 carbon atoms, and the two vicinal radicals R^{A} and R^{B} may also form a monocyclic or polycyclic, substituted or unsubstituted ring system which has from 6 to 40 carbon atoms, wherein R^{A}, R^{B}, R⁵, and R⁶ may also contain heteroatoms selected from the group consisting of the elements Si, N, O and S and may be substituted by at least one halogen atom;
m is 1 or 2,
the radicals X are identical or different and are each a halogen or an organic radical having from 1 to 40 carbon atoms, with two geminal radicals X also being able to be joined to one another; and
o is 0, 1, 2 or 3 with the provision that m+o=2, 3, or 4, depending on the oxidation state of the transition metal.

3. The transition metal complex according to claim 2, wherein the complex is defined by formula (Ia): 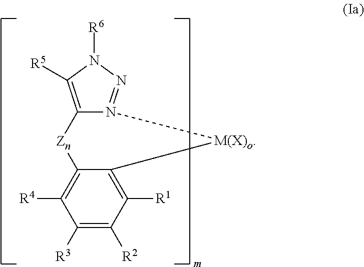
wherein
R¹, R², R³, and R⁴ are identical or different and are each hydrogen or an organic radical having from 1 to 40 carbon atoms, or two vicinal radicals selected from R¹, R², R³, and R⁴ form a monocyclic or polycyclic, substituted or unsubstituted ring system which has from 1 to 40 carbon atoms, wherein R¹, R², R³, and R⁴ may also contain heteroatoms selected from the group consisting of the elements Si, N, O and S and may be substituted by at least one halogen atom.

4. The transition metal complex according to claim 3, wherein
M is zirconium or hafnium,
Z is a bridge selected from —CR¹²R¹³—CR¹⁴R¹⁵—, —CR¹²R¹³—CR¹⁴R¹⁵—CR¹⁶R¹⁷—, —CR¹²═CR¹³—, —CR¹²R¹³—CO—, —CR¹²R¹³—CR¹⁴R¹⁵—CO—, —CR¹²R¹³—O—, —CR¹²R¹³—S—, —CR¹²R¹³—NR¹⁴—, —SiR¹²R¹³—, —Si¹R¹²R¹³—NR¹⁴—, —Si¹R¹²R¹³—O— and —Si¹R¹²R¹³—S—,
R¹², R¹³, R¹⁴, R¹⁵, R¹⁶, and R¹⁷ are each, independently of one another, hydrogen, C₁-C₂₀-alkyl, C₂-C₂₀-alkenyl, C₆-C₂₂-aryl, alkylaryl or alkylaryl having from 1 to 10 carbon atoms in the alkyl part and 6-22 carbon atoms in the aryl part, OR¹⁸ or SiR¹⁸₃, wherein the organic radicals R¹², R¹³, R¹⁴, R¹⁵, R¹⁶, and R¹⁷ may also be substituted by halogens and two vicinal radicals R¹²-R¹⁷ may also be joined to form a five- or six-membered ring and
the radicals R¹⁸ are each independently of one another, hydrogen, C₁-C₂₀-alkyl, C₂-C₂₀-alkenyl, C₆-C₂₂-aryl or alkylaryl having from 1 to 10 carbon atoms in the alkyl part and 6-22 carbon atoms in the aryl part, and two radicals R¹⁸ may also be joined to form a five-, six-, or seven-membered ring,
X are the same or different and are each C₁-C₂₀-alkyl, C₂-C₂₀-alkenyl, C₆-C₂₂-aryl, a C₇-C₂₂-arylalkyl group, —OR¹⁰ or —NR¹⁰R¹¹, where two radicals X may also be joined to one another, wherein the radicals R¹⁰ and R¹¹ are each C₁-C₂₀-alkyl, C₆-C₂₂-aryl, C₇-C₂₂-arylalkyl,
R¹, R², R³, and R⁴ are the same or different and each selected from hydrogen, C₁-C₂₀-alkyl, C₂-C₂₀-alkenyl, C₆-C₂₂-aryl, arylalkyl or alkylaryl having from 1 to 10 carbon atoms in the alkyl radicals and 6-22 carbon atoms in the aryl radical, heteroaryl having from 2 to 21 carbon atoms and from 1 to 3 heteroatoms selected from N, S, and O, heteroarylalkyl or alkylheteroaryl having from 1 to 10 carbon atoms in the alkyl radicals and from 2 to 21 carbon atoms and from 1 to 3 heteroatoms selected from N, S, and O in the aryl radical, and OR⁷, SR⁷, NR⁷₂, SiR⁸₃, where the organic radicals R¹, R², R³, and R⁴ may also be substituted by halogens and/or vicinal radicals R¹, R², R³, and R⁴ may also be joined to form a five-, six- or seven-membered ring and/or two vicinal radicals R¹, R², R³, and R⁴ may be joined to form a five-, six- or seven-membered heterocycle comprising at least one atom from the group consisting of N, O and S, wherein
R⁷ are each, independently of one another, hydrogen, C₁-C₂₀-alkyl, C₂-C₂₀-alkenyl, C₆-C₂₂-aryl, alkylaryl having from 1 to 10 carbon atoms in the alkyl radical and 6-22 carbon atoms in the aryl radical, heteroaryl having from 2 to 21 carbon atoms and from 1 to 3 heteroatoms selected from N, S, and O, heteroarylalkyl or alkylheteroaryl having from 1 to 10 carbon atoms in the alkyl radicals and from 2 to 21 carbon atoms and from 1 to 3 heteroatoms selected from N, S, and O in the aryl radical, SiR⁸₃, where the organic radicals R⁷ may also be substituted by halogens or nitrogen- and oxygen-comprising groups and two radicals R⁷ may also be joined to form a five- or six-membered ring,
R⁸ are each, independently of one another, hydrogen, C₁-C₂₀-alkyl, C₂-C₂₀-alkenyl, C₆-C₂₂-aryl, alkylaryl having from 1 to 10 carbon atoms in the alkyl radical and 6-22 carbon atoms in the aryl radical, heteroaryl having from 2 to 21 carbon atoms and from 1 to 3 heteroatoms selected from N, S, and O, heteroarylalkyl or alkylheteroaryl having from 1 to 10 carbon atoms in the alkyl radicals and from 2 to 21 carbon atoms and from 1 to 3 heteroatoms selected from N, S, and O in the aryl radical where the organic radicals R⁸ may also be substituted by halogens or nitrogen- and oxygen-comprising groups and two radicals R⁸ may also be joined to form a five- or six-membered ring, R⁵ and R⁶ are the same or different and each selected from hydrogen, C₁-C₂₀-alkyl, C₂-C₂₀-alkenyl, C₆-C₂₂-aryl, arylalkyl or alkylaryl having from 1 to 10 carbon atoms in the alkyl radicals and 6-22 carbon atoms in the aryl radical, heteroaryl having from 2 to 21 carbon atoms and from 1 to 3 heteroatoms selected from N, S, and O, heteroarylalkyl or alkylheteroaryl having from 1 to 10 carbon atoms in the alkyl radicals and from 2 to 21 carbon atoms and from 1 to 3 heteroatoms selected from N, S, and O in the aryl radical, and OR⁷, SR⁷, NR⁷₂, SiR⁸₃, where the organic radicals R⁵ and R⁶ may also be substituted by halogens.

5. The transition metal complex according to claim 4, wherein
M is zirconium or hafnium,
Z is a bridge selected from —CR¹²R¹³—, —CR¹²⁻¹³— K S—, or —CR¹²R¹³—NR¹⁴—, wherein
R¹², R¹³, and R¹⁴ are each, hydrogen, C₁-C₂₀-alkyl which may be linear or branched, or
C₆-C₂₂-aryl, which may be substituted by further alkyl groups, wherein two radicals R¹² to R¹⁷ may also be substituted by halogens.

6. The transition metal complex according claim 5, wherein
M is zirconium,
Z is CH₂,
R¹ and R³ are the same and selected from hydrogen, C₁-C₁₀-alkyl, C₂-C₁₀-alkenyl, C₆-C₁₀-aryl, arylalkyl or alkylaryl having from 1 to 10 carbon atoms in the alkyl radicals and 6-10 carbon atoms in the aryl radical, NR⁷₂, SiR⁸₃, or OR⁸ where the organic radicals R¹ and R³ may also be substituted by halogens,
R² and R⁴ are each hydrogen,
R⁵ is selected from hydrogen, C₁-C₈-alkyl radicals, C₆-C₂₂-aryl radicals, and C₇-C₂₂-arylalkyl radicals,
R⁶ is selected from C₁-C₈-alkyl radicals, C₆-C₂₂-aryl radicals, and C₇-C₂₂-arylalkyl radicals,
R⁷ is C₁-C₁₀-alkyl, C₂-C₁₀-alkenyl, or C₆-C₁₀-aryl,
R⁸ is C₁-C₁₀-alkyl, C₂-C₁₀-alkenyl, or C₆-C₁₀-aryl, and
X are identical and each an C₆-C₂₂-aryl radical or arylalkyl having from 1 to 10 carbon atoms in the alkyl radicals and 6-10 carbon atoms in the aryl radical.

7. A catalyst system for polymerization of olefins comprising the product obtained by contacting:
a transition metal complex according to claim 1, and
a cocatalyst.

8. The catalyst system according to claim 7 further comprising a support.

9. A process comprising polymerizing or copolymerizing olefins carried out in the presence of a catalyst system according to claim 7.

10. The process according to claim 9 wherein ethylene is polymerized or copolymerized.

11. The transition metal complex according to claim 6, wherein the halogen which may substitute the organic radicals R¹ and R³ is fluorine.
